(19) United States
(12) Patent Application Publication
(10) Pub. No.: US 2014/0258509 A1
(43) Pub. Date: Sep. 11, 2014

(54) SYSTEMS AND METHODS FOR CONTEXT-BASED NETWORK DATA ANALYSIS AND MONITORING

(71) Applicant: AEROHIVE NETWORKS, INC., Sunnyvale, CA (US)

(72) Inventors: Praveen Raghuraman, Cupertino, CA (US); Weimin Du, San Jose, CA (US)

(73) Assignee: AEROHIVE NETWORKS, INC., Sunnyvale, CA (US)

(21) Appl. No.: 14/194,560

(22) Filed: Feb. 28, 2014

Related U.S. Application Data
(60) Provisional application No. 61/772,540, filed on Mar. 5, 2013.

(51) Int. Cl. H04L 12/26

(52) U.S. Cl. CPC H04L 43/0876
USPC 709/224

(57) ABSTRACT

Particular network usage information representing network activity of a particular device on a network is received. The particular network usage information is associated with a network context, the network context representing circumstances of the network activity of the particular device. The network context is associated with a particular network perspective, the network particular perspective representing a network activity of a group of devices on the network. The particular network perspective is rendered into an object, the object being configured to present the particular network perspective in a graphical user interface.

### CLAIM OF PRIORITY

The present application claims priority to U.S. Provisional Patent Application Ser. No. 61/772,540, filed Mar. 5, 2013 and entitled “Systems and Methods for Context-Based Network Data Analysis and Monitoring,” the contents of which are hereby incorporated by reference herein.

### BACKGROUND

Many organizations find it important to provide users with access to computer networks. As an example, a hospital may find it important to provide doctors, other health professionals, and patients with the ability to access health information networks containing information about symptoms, potential diagnoses, and potential treatments. As another example, a school may find it important to provide teachers, students, and others with the ability access online educational materials. As yet another example, a business may find it important to provide employees, contractors, and guests with varying levels of network access. Many organizations have implemented network access tools, such as network access points, to provide users with access to computer networks. Providing computer network access to users, however, may present problems for an organization. A system allowing the organization to efficiently monitor usage of the organization's network would prove useful.

### SUMMARY

In various implementations, there is provided a contextual visibility dashboard allowing network administrators insight around key dimensions of network visibility. Such insight can inform network visibility and policy enforcement through customizable perspectives and custom placement of objects within a perspective. Such a dashboard can allow network administrators to visualize network traffic based on different contextual elements, including location, identity, network times, device context(s), and other factors.

Disclosed, in an implementation, particular network usage information representing network activity of a particular device on a network is received. The particular network usage information is associated with a network context, the network context representing circumstances of the network activity of the particular device. The network context is associated with a particular network perspective, the network particular perspective representing a network activity of a group of devices on the network. The particular network perspective is rendered into an object, the object being configured to present the particular network perspective in a graphical user interface.

The particular device can comprise one or more of a network access system, a wireless system, and a wired system. The group of devices can comprise one or more of a network access system, a wireless system, and a wired system. In an implementation, information about the network activity by the group of devices is collected before receiving the particular network usage information.

The network is can comprise an edge network, and the particular network usage information can be related to the edge network. The network can comprise an edge network, and the network activity of the group of devices can be associated with the group of devices in relation to the edge network. The network can comprise an edge network, and the method can further comprise interfacing with a core network.

In an implementation, the network activity of the particular device comprises one or more of: a location of the particular device, a user identifier of a user of the particular device, connectivity parameters used to connect the particular device to the network, an access time of the particular device to the network, an application of the particular device used to access the network, and a logical network access group the particular device belongs to. In an implementation, the circumstances comprise one or more of: a common location of one or more of the group of devices, a user identifier of a user of one or more of the group of devices, connectivity parameters used to connect one or more of the group of devices to the network, an access time of one or more of the group of devices to the network, an application of one or more of the group of devices commonly used to access the network, and a logical network access group of one or more of the group of devices. In an implementation, the network activity of the group of devices comprises: network access parameters of the group of devices, system configurations of the group of devices, networked applications of the group of devices, Bring Your Own Device designations of the group of devices, network troubleshooting parameters of the group of devices, and custom parameters of the group of devices.

The particular network perspective can comprise one or more of: a network summary of the group of devices, an application perspective of the group of devices, a bring-your-own-device perspective for the group of devices, a troubleshooting perspective for the group of devices, or a custom perspective for the group of devices. The object can be adapted to be integrated into a webpage or an application for an administrator of the network. The object can comprise an embeddable widget.

In an implementation, the graphical user interface can comprise another object, the other object rendering another particular network perspective, the other particular network perspective representing a third measure of network activity, the third measure of network activity being by the group of devices on the network.

The object can comprise one or more of: a pie chart, a bar graph, and a line chart. In an implementation associating the particular network usage information with the network context can comprise applying a context filter to the particular network usage information, the context filter translating the particular measure of network activity to the circumstances of the network activity.

Associating the network context with the particular network perspective can comprise applying a network perspective filter to the network context, the perspective filter translating the circumstances of the network activity to the second measure of the network activity.

In an implementation, a report is generated, the report representing the particular network perspective in at least a partially textual format. In an implementation, the report is transmitted to an administrator of the network.

A system can comprise: a network data collection engine; a context association engine coupled to the network data collection engine; a perspective association engine coupled to the context association engine; an object rendering engine coupled to the perspective association engine. In operation, the network data collection engine receives particular network usage information, the particular network usage information representing network activity of a particular device on a network; the context association engine associates the particular network usage information with a network context, the network context representing circumstances of the network activity of the particular device; the perspective association engine associates the network context with a particular network perspective, the network particular perspective representing a network activity of a group of devices on the network; the object rendering engine renders the particular network perspective into an object, the object being configured to present the particular network perspective in a graphical user interface.

A system can comprise: means for receiving particular network usage information, the particular network usage information representing network activity of a particular device on a network; means for associating the particular network usage information with a network context, the network context representing circumstances of the network activity of the particular device; means for associating the network context with a particular network perspective, the network particular perspective representing a network activity of a group of devices on the network; means for rendering the particular network perspective into an object, the object being configured to present the particular network perspective in a graphical user interface.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for managing network data, in accordance with some implementations.

FIG. 2 depicts a diagram illustrating an example of a context-based network data perspective system, in accordance with some implementations.

FIG. 3 depicts a diagram illustrating an example of a context-based network data perspective system, in accordance with some implementations.

FIG. 4 depicts a flowchart of an example of a method for managing network data in accordance with some implementations.

FIG. 5 depicts an example of a screen for displaying a network summary perspective, in accordance with some implementations.

FIG. 6 depicts an example of a screen for displaying a system summary perspective, in accordance with some implementations.

FIG. 7 depicts an example of a screen for displaying a troubleshooting perspective, in accordance with some implementations.

FIG. 8 depicts an example of a screen for displaying a BYOD perspective, in accordance with some implementations.

FIG. 9 depicts an example of a screen for displaying an applications perspective, in accordance with some implementations.

FIG. 10 depicts an example of a screen for displaying a particular application perspective, in accordance with some implementations.

FIG. 11 depicts an example of a screen for displaying a particular user perspective, in accordance with some implementations.

FIG. 12 depicts a screen including an example user interface for creating an example custom perspective in accordance with some implementations.

FIG. 13 depicts an example of a screen including an example user interface for creating an example custom perspective in accordance with some implementations.

FIG. 14 depicts an example of a screen including an example user interface for creating an example custom perspective in accordance with some implementations.

FIG. 15 depicts an example of a computer system, in accordance with some embodiments.

FIG. 16 depicts a diagram illustrating examples of contextual elements and examples of various perspective views, in accordance with some embodiments.

### DETAILED DESCRIPTION

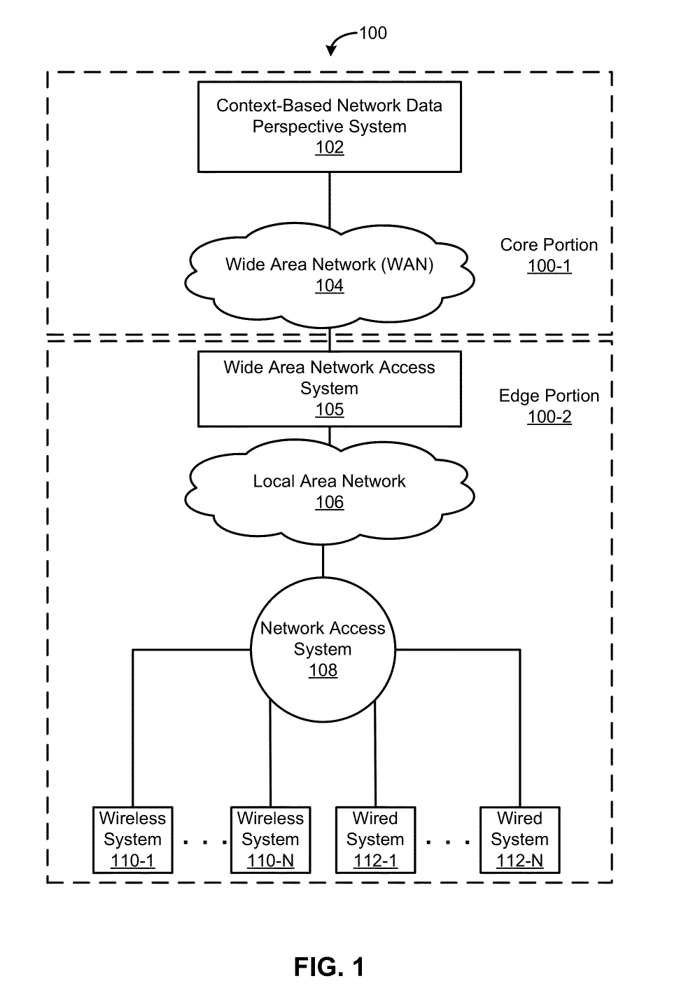

FIG. 1 depicts a diagram of an example of a system 100 for managing network data, in accordance with some implementations. In the example of FIG. 1, the system 100 includes a core portion 100-1 and an edge portion 100-2. The system 100 further includes a context-based network data perspective system 102, a wide area network (WAN) 104, a WAN access system 105, a local area network (LAN) 106, a network access system 108, wireless systems 110-1 through 110-N (wireless systems 110), and wired systems 112-1 through 112-N (wired systems 112).

In the example of FIG. 1, the core portion 100-1 comprises the WAN 104 and the context-based network data perspective system 102. In a specific implementation, the core portion 100-1 is administered by a service provider who is associated with the WAN 104, such as an Internet Service Provider (ISP). The core portion 100-1 may correspond to a “core network,” as used in this paper.

In the example of FIG. 1, the edge portion 100-2 comprises the WAN access system 105, the LAN 106, the network access system 108, the wireless systems 110, and the wired systems 112. In various implementations, the edge portion 100-2 is associated with a network administrator, also referred to as a “user” in this paper. In an implementation, the network administrator is charged with administering network and other policies for other portions of the LAN 106, such as the WAN access system 105 and/or the network access system 108. In some implementations, the edge portion 100-1 may be associated with an organization. An organization, as used in this paper, is intended to be construed broadly and can refer to any entity that networks devices in a manner more specific than the coupling of two devices over the Internet. In a specific implementation, an organization can include an enterprise. An organization can also refer to a hospital, a school, a business, or other entity. An organization can refer a common geographical space, such as a set of buildings or a campus. In some implementations, an organization can refer to a geographically dispersed entity, such as a corporation, maintaining portions of the edge portion 100-2 in various geographic locations. The edge portion 100-2 may correspond to an “edge network,” as used in this paper.

In the example of FIG. 1, the context-based network data perspective system 102 is coupled to the WAN 104. In a specific implementation, the context-based network data perspective system 102 is configured to manage network data. More specifically, the context-based network data perspective system 102 is configured to group network activity of the wireless systems 110 and/or the wired systems 112 into one or more network contexts representing the circumstances of the network activity. In a specific implementation, the context-based network data perspective system 102 uses the one or more network contexts to provide one or more network perspectives into the behaviors underlying the network activity, including attributes of the wireless systems 110 and/or the wired systems 112 and/or users of the wireless systems 110 and/or the wired systems 112. The context-based network data perspective system 102 is further configured to render the network contexts and/or network perspectives into a graphical user interface (GUI) so network activity is effectively managed. In some implementations, the context-based network perspective data perspective system 102 maintains specific particular contexts, filters, and/or perspectives even when an administrator has switched between contexts, filters, and/or perspectives or administration sessions. More specifically, the context-based network perspective data perspective system 102 can remember contexts, filters, and/or perspectives applied to a set of devices even after the administrator has shifted to other contexts, filters, and/or perspectives. The context-based network perspective data perspective system 102, and the other engines in this paper, may greatly assist in improving productivity of administrators. In a specific implementation, the context-based network data perspective system 102 is implemented as a computer system.

In a particular implementation, the network management features of the context-based network data perspective system 102 are applied to network activity associated with the edge portion 116. More specifically, particular implementations can provide context-based information regarding network data traveling through network access stations, such as wireless access points (WAP), wireless routers, and the like, which may be associated with an enterprise network and represent the edge of the enterprise network (hereafter, also referred to as the “enterprise edge”). In a specific implementation, the context-based network data perspective system 102 includes one or more engines and/or one or more datastores, as the terms “engine” and “datastore” are used in this paper.

An engine, as used in this paper, includes a dedicated or shared processor and, typically, firmware or software modules executed by the processor. Depending upon implementation-specific or other considerations, an engine can be centralized or its functionality distributed. An engine can include special purpose hardware, firmware, or software embodied in a computer-readable medium for execution by the processor.

A datastore, as used in this paper, can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper. Datastores can include data structures. As used in this paper, a data structure is associated with a particular way of storing and organizing data in a computer so it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures for creating and manipulating instances of that structure.

In the example of FIG. 1, the WAN 104 is coupled to the context-based network data perspective system 102 and to the WAN access system 105. In a specific implementation, the WAN 104 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the WAN 104 broadly includes, as understood from relevant context, anything from a minimalist coupling of the components illustrated in the example of FIG. 1, to every component of the Internet and networks coupled to the Internet. In some implementations, the WAN 104 is administered by a service provider, such as an Internet Service Provider (ISP).

In various implementations, the WAN 104 may include technologies such as Ethernet, 802.11, worldwide interoperability for microwave access (WiMAX), 3G, 4G, CDMA, GSM, LTE, digital subscriber line (DSL), etc. The WAN 104 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the WAN 104 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In the example of FIG. 1, the WAN access system 105 is coupled to the WAN 104 and to the LAN 106. In a specific implementation, the WAN access system 105 provides access to the WAN 104 for all systems within the edge portion 116. More specifically, in a specific implementation, the WAN access system 105 links systems within the edge portion 116 together so the systems within the edge portion 116 may have access to the WAN 104. In various implementations, the WAN access system 105 is implemented as one or more of a gateway, a switch, a router, and a bridge providing access to the WAN 104. In some implementations, the WAN access system 105 is administered by the network administrator who is associated with the context-based network data perspective system 102 and/or is charged with administering network and other policies for the edge portion 116.

In the example of FIG. 1, the LAN 106 is coupled to the WAN access system 105 and to the network access system 108. In a specific implementation, the LAN 106 may provide a network linking the wireless systems 110 and/or the wired systems 112 to each other and/or to the WAN 104. In some implementations, the LAN 106 is associated with the edge portion 116. The LAN 106 can also be administered by the network administrator who is associated with the context-based network data perspective system 102 and/or is charged with administering network and other policies for the edge portion 116.

In a specific implementation, the LAN 106 includes a wired network using wires for at least some communications. In some implementations, the LAN 106 comprises a wireless network. A “wireless network,” as used in this paper may include any computer network communicating at least in part without the use of electrical wires. In various implementations, the LAN 106 includes technologies such as Ethernet, 802.11, worldwide interoperability for microwave access (WiMAX), 3G, 4G, CDMA, GSM, LTE, digital subscriber line (DSL), etc. The LAN 106 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the LAN 106 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the LAN 106 is compatible with the 802.11 protocols specified by the Institute of Electrical and Electronics Engineers (IEEE). The LAN 106 may be compatible with one or more stations. A “station,” as used in this paper, may refer to a device with a media access control (MAC) address and a physical layer (PHY) interface to a wireless medium complying with the IEEE 802.11 standard. Thus, for example, stations and a wireless access point (WAP) with which the stations associate can be referred to as stations, if applicable. IEEE 802.11a-1999, IEEE 802.11b-1999, IEEE 802.11g-2003, IEEE 802.11-2007, and IEEE 802.11n TGn Draft 8.0 (2009) are incorporated by reference. A system that is 802.11 standards-compatible or 802.11 standards-compliant, as used in this paper, may comply with at least some of one or more of the incorporated documents' requirements and/or recommendations, or requirements and/or recommendations from earlier drafts of the documents, and includes Wi-Fi systems. Wi-Fi is a non-technical description, which is generally correlated with the IEEE 802.11 standards, as well as Wi-Fi Protected Access (WPA) and WPA2 security standards, and the Extensible Authentication Protocol (EAP) standard. In alternative implementations, a station may comply with a different standard than Wi-Fi or IEEE 802.11, may be referred to as something other than a “station,” and may have different interfaces to a wireless or other medium.

In a specific implementation, the wireless network of the LAN 106 is compatible with the 802.3 protocols specified by the IEEE. In some implementations, IEEE 802.3 compatible protocols of the LAN 106 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the LAN 106. These standards provide the basis for wireless network products using the Wi-Fi brand. IEEE 802.1 and 802.3 are incorporated by reference.

In the example of FIG. 1, the network access system 108 is coupled to the LAN 106, to the wireless systems 110, and to the wired systems 112. In a specific implementation, the network access system 108 provides access to the LAN 106 and/or the WAN 104. In a specific implementation, the network access system 108 is implemented as one or more of a network access point, a gateway, a switch, a router, and a bridge. In some implementations, the network access system 108 is implemented as: a wireless network access point to supply wireless network access to the LAN 106 and/or the WAN 104; and/or a wired access point to supply wired network access to the LAN 106 and/or the WAN 104. In some implementations, the network access system 108 is associated with the edge portion 116. The network access system 108 can also be administered by the network administrator who is associated with the context-based network data perspective system 102 and/or is charged with administering network and other policies for the edge portion 116.

Though FIG. 1 shows the network access system 108 as distinct from the WAN access system 105, in various implementations, the functionalities of the network access system 108 and the WAN access system 105 may be interchanged or consolidated into a single system. More specifically, in some implementations, the network access system 108 provides direct access to the WAN 104. In these implementations, the network access system 108 can nonetheless be associated with edge portion 116 and administered by the network administrator who is associated with the context-based network data perspective system 102 and/or is charged with administering network and other policies for the edge portion 116.

In the example of FIG. 1, the wireless systems 110 may be coupled to the network access system 108. In a specific implementation, the wireless systems 110 may access resources of the LAN 106 and/or the WAN 104 using a wireless network connection. In a specific implementation, the wireless systems 110 include one or more computer systems. In the example of FIG. 1, the wired systems 112 may be coupled to the network access system 108. In a specific implementation, the wired systems 112 may access resources of the LAN 106 and/or the WAN 104 using a wired network connection. In a specific implementation, the wired systems 112 include one or more computer systems.

Though FIG. 1 shows the context-based network data perspective system 102 as coupled to the WAN 104, it is noted, in various implementations, the context-based network data perspective system 102 may be coupled to the LAN 106. More specifically, the context-based network data perspective system 102 may be associated with the edge portion 116 and may reside on the LAN 106.

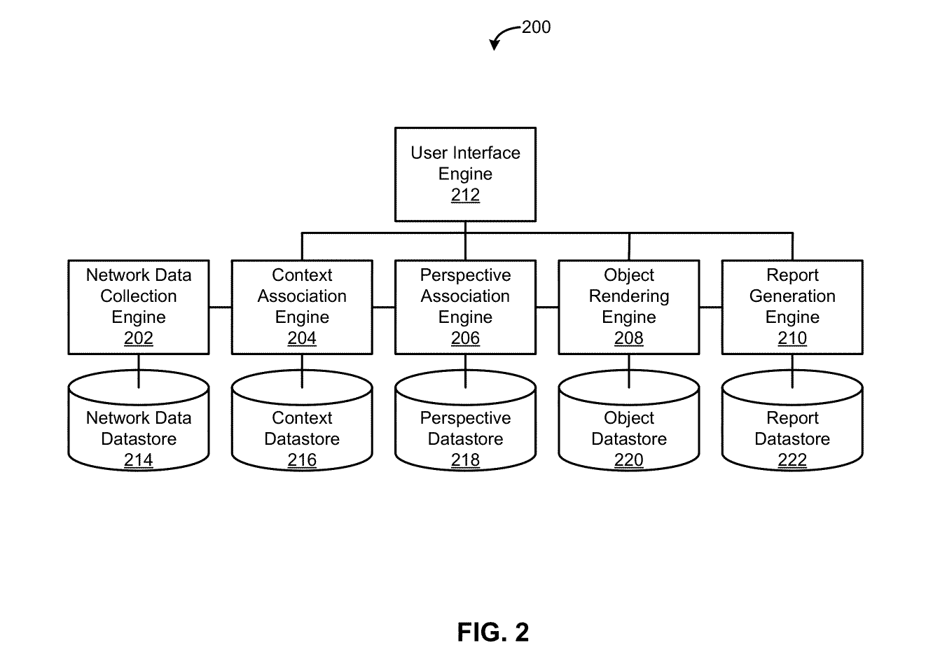

FIG. 2 depicts a diagram illustrating an example of a context-based network data perspective system 200, in accordance with some implementations. In the example of FIG. 2, the context-based network data perspective system 200 includes a network data collection engine 202, a context association engine 204, a perspective association engine 206, an object rendering engine 208, a report generation engine 210, and a user interface engine 212. The context-based network data perspective system 200 further includes a network data datastore 214, a context datastore 216, a perspective datastore 218, an object datastore 220, and a report datastore 222.

In a specific implementation, each of the network data collection engine 202, the context association engine 204, the perspective association engine 206, the object rendering engine 208, the report generation engine 210, and the user interface engine 212 can include an “engine” as referred to in this paper. In a specific implementation, each of the network data datastore 214, the context datastore 216, the perspective datastore 218, the object datastore 220, and the report datastore 222 can include a “datastore” as referred to in this paper.

In the example of FIG. 2, the network data collection engine 202 is coupled to the network data datastore 214, the context association engine 204, and a network (e.g., the WAN 104 and/or the LAN 106 shown in FIG. 1). In a specific implementation the network data collection engine 202 monitors network activity on the WAN 104 and/or the LAN 106. In some implementations, the network data collection engine 202 is integrated into network interface of the context-based network data perspective system 200. In various implementations, the network data collection engine 202 stores attributes of the monitored network activity in the network data datastore 214. The network data collection engine 202 can also provide a measure of monitored network activity to the context association engine 204.

In some implementations, the monitored network activity can include network activity of the network access system 108, the WAN access system 105, the wireless systems 110, and/or the wired systems 112 (shown in FIG. 1). The monitored network activity can also include network activity of other devices coupled to the WAN 104 and/or the LAN 106. In a specific implementation, the network data collection engine 202 is configured to monitor network traffic of all devices residing within the edge portion 100-1 (shown in FIG. 1).

In a particular implementation, the monitoring of the network activity occurs on various levels of the Open Systems Interconnection (OSI) Model. For instance, the network data collection engine 202 can monitor the payload of data packets on the WAN 104 and/or the LAN 106 to infer network activity from the payload of the data packets. In some implementations, the network data collection engine 202 may obtain the identities, locations, times, destinations, sources, network configurations, and other information related to users and/or devices trying to access the WAN 104 and/or the LAN 106.

In the example of FIG. 2, the context association engine 204 is coupled to the network data collection engine 202, the perspective association engine 206, the context datastore 216, and the user interface engine 212. In a specific implementation, the context association engine 204 receives a measure of monitored network activity from the network data collection engine 202. The context association engine 204 can also associate a network context with the measure of network activity. In various implementations, associating the network context may include applying a network context filter to the network activity. The contexts of the network activity can include information about the circumstances of the network activity. The network context can include one or more elements (referred to in this paper as “contextual elements”), each providing a different category of contextual information with respect to the networks. The information provided by a given contextual element can include facts, conditions, or circumstances regarding the networks. Examples of contextual elements can include those relating to location (e.g., geographic location, location with respect to a structure such as building, or the like), activities (e.g., activity type, task, project, or the like), applications (e.g., specific application, or application type), users (e.g., identifiers of users or user groups), date or time, network connectivity, network-enabled devices, and the like.

In a specific implementation, the context association engine 204 provides the network context to the perspective association engine 206. The context association engine 204 can also store network context(s) in the context datastore 216. The context association engine 204, in an implementation, provides contexts to the user interface engine 212 for an administrator to select, view and/or modify.

In an implementation, the context association engine 204 maintains the network context even after the user applies other network contexts to the network activity. In various embodiments, the context association engine 204 can store the network context in the context datastore 216.

In the example of FIG. 2, the perspective association engine 206 is coupled to the context association engine 204, the object rendering engine 208, the perspective datastore 218, and the user interface engine 212. In a specific implementation, the perspective association engine 206 receives network context(s) from the context association engine 204. The perspective association engine 206 can also associate network perspective(s) with the network context(s) provided thereto. In various implementations, associating network perspective(s) with the network context(s) may include applying network perspective filters to the network context(s).

In a specific implementation, the perspective association engine 206 provides the network perspective to the object rendering engine 208. The perspective association engine 206 can also store network perspective(s) in the perspective datastore 218. The perspective association engine 206, in an implementation, provides perspectives to the user interface engine 212 for an administrator to select, view and/or modify.

In the example of FIG. 2, the object rendering engine 208 is coupled to the perspective association engine 206, the report generation engine 210, the object datastore 220, and the user interface engine 212. In a specific implementation, the object rendering engine 208 receives perspectives from the perspective association engine 206. The object rendering engine 208 can also render the perspectives into visible objects for display. The visible objects may be adapted to be integrated into a webpage, an application for the administrator, may comprise an embeddable widget, or may take other forms.

In a specific implementation, the object rendering engine 208 provides objects to the user interface engine 212. The object rendering engine 208 can also provide objects to the report generation engine 210. In an implementation, the object rendering engine 208 stores the objects in the object datastore 220.

In the example of FIG. 2, the report generation engine 210 is coupled to the object rendering engine 208, the report datastore 222, and the user interface engine 212. In a specific implementation, the report generation engine 210 generates reports based on one or more of the network activity, network context(s), network perspective(s), and information in object(s). The report generation engine 210 can provide the report(s) to the user interface engine 212 for display. The report generation engine 210 can also store report(s) in the report datastore 222.

In the example of FIG. 2, the user interface engine 212 is coupled to the context association engine 204, the perspective association engine 206, the object rendering engine 208, and the report generation engine 210. In a specific implementation, the user interface engine 212 is configured to interface with the network administrator. The user interface engine 212 can receive input from the network administrator. The user interface engine 212 can also configure a graphical user interface (GUI) for use by the network administrator.

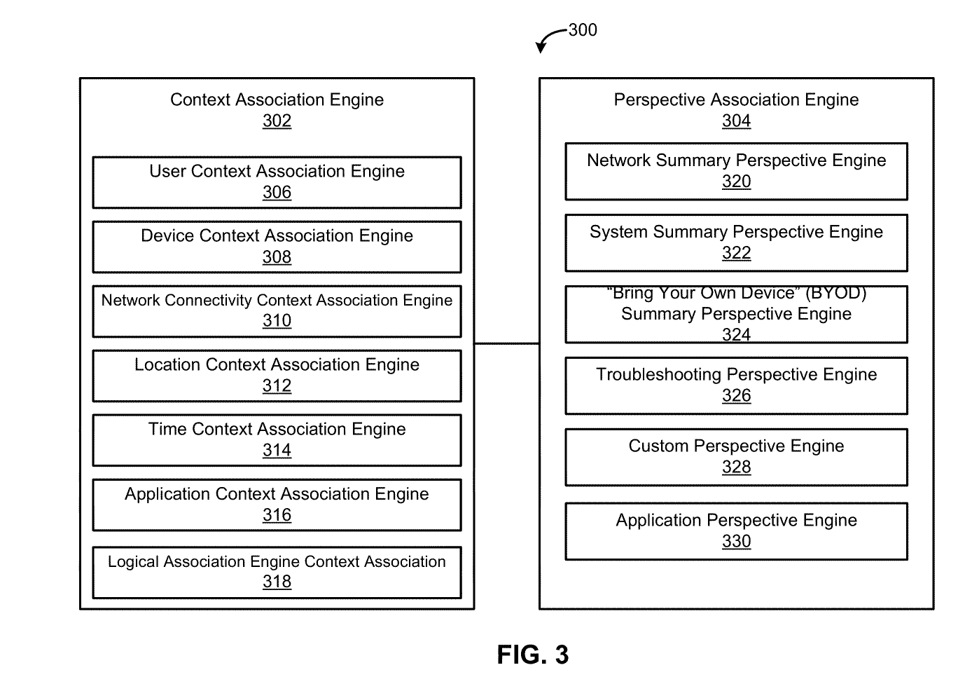

FIG. 3 depicts a diagram illustrating an example of a context-based network data perspective system 300, in accordance with some implementations. In the example of FIG. 3, the context-based network data perspective system 300 includes a context association engine 302 and a perspective association engine 304.

In the example of FIG. 3, the context association engine 302 is coupled to the perspective association engine 304. In this example, the context association engine 302 includes a user context association engine 306, a device context association engine 308, a network connectivity context association engine 310, a location context association engine 312, a time context association engine 314, an application context association engine 316, and a logical context association engine 318. In various implementations, one or more of the user context association engine 306, the device context association engine 308, the network connectivity context association engine 310, the location context association engine 312, the time context association engine 314, the application context association engine 316, and the logical context association engine 318 includes an “engine,” as referred to in this paper.

In a specific implementation, the user context association engine 306 associates a user context with the network activity. The user context can include circumstances relevant to monitoring a user or group of users of the WAN 104 and/or LAN 106. Examples of user contexts include user identifiers, user types, user groups, and other circumstances that would help identify how specific users or people are using the WAN 104 and/or LAN 106. In various implementations, the user context association engine 306 compares attributes of the monitored network activity against datastores of user identifiers, user types, user groups, etc. Additional examples of user contexts include the role of a user in an organization (e.g., whether the user is a doctor, nurse, patient in a hospital; whether the user is a teacher, student, employee, etc. in a school; whether the user is an employee, contractor, guest, etc., in an enterprise). In a specific implementation, user contexts may allow a network administrator to determine access rights, privileges, and other rights for users.

In an implementation, the device context association engine 308 associates a device context with the network activity. The device context can include circumstances relevant to monitoring a device or group of devices on the WAN 104 and/or the LAN 106. Examples of device contexts include manufacturers, models, types, operating systems, and other information of devices on the WAN 104 and/or the LAN 106. In some implementations, the device context association engine 308 compares attributes of the monitored network activity against datastores of manufacturers, models, types, operating systems, etc.

In a certain implementation, the network connectivity context association engine 310 associates a network connectivity context with the network activity. The network connectivity context can include circumstances relevant to monitoring connectivity attributes of users/devices on the WAN 104 and/or the LAN 106. Examples of network connectivity contexts include subscriber station identifiers (SSID) of wireless devices, wireless protocols used to access the WAN 104 and/or the LAN 106, encryption protocols, Layer-2 or Layer-3 network information, and other information. In some implementations, the network connectivity context association engine 310 compares attributes of the monitored network activity against datastores of SSIDs, wireless protocols, encryption protocols, etc.

In some implementations, the location context association engine 312 associates a location context with the network activity. The location context can include information about the location of users and/or devices on the WAN 104 and/or LAN 106. Examples of location contexts can include locations of access points or devices. In some implementations, the location context association engine 312 compares attributes of the monitored network activity against datastores holding location context information. In various implementations, the location context comprises a hierarchical location context. An example of a hierarchical location context may information about whether the network activity belongs to a given country, state, city, block, building, floor, and specific location on the floor.

In an implementation, the time context association engine 314 associates a time context with the network activity. The time context can include information about the time of access events related to the WAN 104 and/or LAN 106. The time context can provide network usage or performance within a window of time.

In a specific implementation, the application context association engine 316 associates an application context with the network activity. The application context can include information about applications associated with the network activity. In various implementations, the application context association engine 316 scans the payload of network traffic to determine particular applications and/or particular destinations (e.g., particular websites) the network traffic is associated with. Network activity associated with applications like Facebook® and file sharing programs, or with YouTube® and other websites can thus be discerned. In some implementations, the application context association engine 316 compares attributes of the monitored network activity against datastores holding application information.

In an implementation, the logical context association engine 318 associates a logical context with the network activity. The logical context can include information about logical network groups the network activity is associated with. For example, the logical context association engine 318 can associate the network activity with a specific virtual LAN (VLAN) used by an enterprise, a hospital, an organization, a school, or a group of enterprises, hospitals, organizations, and schools. The logical context association engine 318 can compare attributes of the monitored network activity against datastores holding logical context information. In various implementations, the logical context may comprise a hierarchical logical context. An example of a hierarchical logical context may include whether the network activity belongs to a group at a given level (e.g., all high schools in a geographically dispersed school district or all administration buildings in a geographically dispersed school district).

In the example of FIG. 3, the perspective association engine 304 is coupled to the context association engine 302. In this example, the perspective association engine 304 includes a network summary perspective engine 320, a system summary perspective engine 322, a BYOD summary perspective engine 324, a troubleshooting perspective engine 326, a custom perspective engine 328, and an application perspective engine 330. In various implementations, one or more of the network summary perspective engine 320, the system summary perspective engine 322, the BYOD summary perspective engine 324, the troubleshooting perspective engine 326, the custom perspective engine 328, and the application perspective engine 330 includes an “engine,” as referred to in this paper.

In an implementation, the network summary perspective engine 320 provides a network summary perspective of the WAN 104 and/or the LAN 106. Based on the network context from the context association engine 302, the network summary perspective engine 320 can provide perspectives related to unique clients over a period of time, top access points by usage, top access points by unique clients, top access points by channel utilization, and other perspectives, for instance.

In an implementation, the system summary perspective engine 322 provides a system summary perspective of the WAN 104 and/or the LAN 106. Based on the network context from the context association engine 302, the system summary perspective engine 322 can provide perspectives related to operating systems of devices, audit logs of access points, access points at an up or down state, and current access point alarms, for instance.

In a specific implementation, the BYOD summary perspective engine 324 provides a BYOD summary of the WAN 104 and/or the LAN 106. Based on the network context from the context association engine 302, the BYOD summary perspective engine 324 can provide perspectives related to top clients by client counts, unique clients by SSID, unique clients over time, and maximum concurrent clients over a unit of time, for example.

In a particular implementation, the troubleshooting perspective engine 326 provides a troubleshooting perspective of the WAN 104 and/or the LAN 106. Based on the network context from the context association engine 302, the troubleshooting perspective engine 326 can provide perspectives related top access points by channel utilization, top access points by retries, top devices by network errors, and top access points by airtime utilization, for instance.

In an implementation, the custom perspective engine 328 provides a system administrator with a custom perspective of the WAN 104 and/or the LAN 106. Based on the network context from the context association engine 302, the custom perspective engine 328 can provide custom perspectives. Examples of custom perspectives can include combinations of perspectives related to other categories.

In an implementation, the application perspective engine 330 provides an application perspective of the WAN 104 and/or the LAN 106. Based on the network context from the context association engine 302, the application perspective engine 330 can provide perspectives related to top applications by network usage, top users by network usage, top applications by bandwidth usage, for example.

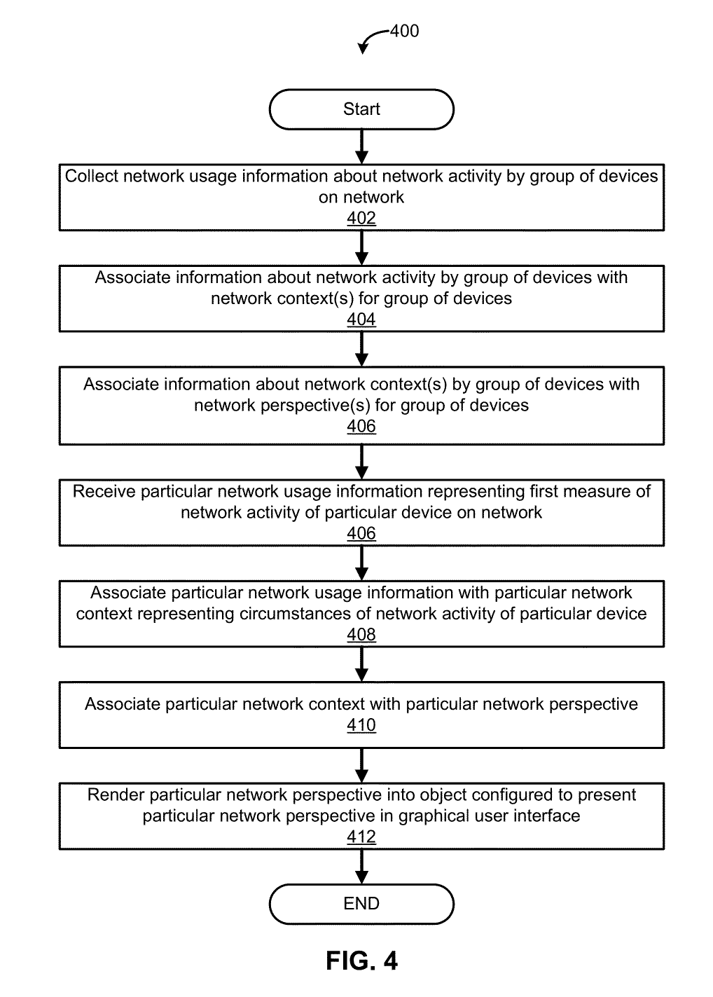

FIG. 4 depicts a flowchart of an example of a method 400 for managing network data in accordance with some implementations. The method 400 is discussed in conjunction with various implementations of the context-based network data perspective system 200, shown in FIG. 2.

At block 402, network usage information about network activity by a group of devices on a network is collected. In a specific implementation, the network data collection engine 202 collects the network activity about devices on the WAN 104 and/or LAN 106. The network data collection engine 202 can further provide a measure of monitored network activity to the context association engine 204. In some implementations, the monitored network activity can include network activity of the network access system 108, the WAN access system 105, the wireless systems 110, and/or the wired systems 112 (shown in FIG. 1). In a particular implementation, the monitoring of the network activity occurs on various levels of the Open Systems Interconnection (OSI) Model. For instance, the network data collection engine 202 can monitor Layer-2 and/or Layer-3 traffic on the WAN 104 and/or LAN 106 to determine network activity related to the traffic.

At block 404, information about the network activity by the group of devices is associated with one or more network contexts for the group of devices. In a specific implementation, the context association engine 204 associates the network activity with one or more network contexts. In some implementations, the user interface engine 212 receives instructions to associate a particular context with the network activity. In various implementations, the context association engine 204 can provide contexts relating to one or more of: information related to users accessing the WAN 104 and/or the LAN 106, information about devices accessing the WAN 104 and/or the LAN 106, information about specific network connections or configurations of devices accessing the WAN 104 and/or the LAN 106, the location of one or more devices accessing the WAN 104 and/or the LAN 106, the time of access to the WAN 104 and/or the LAN 106, specific applications devices are trying to access using the WAN 104 and/or the LAN 106, and other logical information relating to devices trying to access the WAN 104 and/or the LAN 106.

In an implementation, the context association engine 302, shown in FIG. 3 associates a network context with the network activity. For example, the user context association engine 306 can associate a user context with the network activity. Also, the device context association engine 308 can associate a device context with the network activity. The network connectivity context association engine 310 can associate a network connectivity context with the network activity. The location context association engine 312 can associate a location context with the network activity. The time context association engine 314 can associate a time context with the network activity. The application context association engine 316 can associate an application context with the network activity. Moreover, the logical context association engine 318 can associate a logical context with the network activity.

At block 406, information about the one or more network contexts is associated with one or more network perspectives for the group of devices. In a specific implementation, the perspective association engine 206 associates one or more network perspectives with the one or more network contexts. The perspectives can include how the network context fits into a larger pattern of network activity by a group of devices on the WAN 104 and/or the LAN 106. In an implementation, the perspectives can include anything allowing the network administrator to understand a piece of the WAN 104 and/or LAN 106 and how the piece is being used. Examples of perspectives include network summary perspectives, network application perspectives, BYOD perspectives, troubleshooting perspectives, and/or custom perspectives. Each of these perspectives can allow the network administrator to understand network activity on the WAN 104 and/or the LAN 106 on a larger scale.

In an implementation, the perspective association engine 304, shown in FIG. 3 associates a network perspective with the network context. In an implementation, the network summary perspective engine 320 provides a network summary perspective of the WAN 104 and/or the LAN 106. The system summary perspective engine 322 can provide a system summary perspective of the WAN 104 and/or the LAN 106. The BYOD summary perspective engine 324 can provide a BYOD summary of the WAN 104 and/or the LAN 106. The troubleshooting perspective engine 326 can provide a troubleshooting perspective of the WAN 104 and/or the LAN 106. The custom perspective engine 328 can provide a system administrator with a custom perspective of the WAN 104 and/or the LAN 106. Further, the application perspective engine 330 can provide an application perspective of the WAN 104 and/or the LAN 106.

At block 408, particular network information representing a first measure of network activity of a particular device on the network is received. In an implementation, the network data collection engine 202 collects particular network activity about a particular device on the WAN 104 and/or LAN 106.

At block 410, the particular usage information is associated with a particular network context representing circumstances of the network activity of the particular device. In a specific implementation, the context association engine 204 associates a network context with the particular network activity. The context association engine 302 can also associate a particular network context with the particular network activity.

At block 412, the particular network context is associated with the particular network perspective. In a certain implementation, the perspective association engine 206 associates a network perspective with the particular network context. The perspective association engine 304, shown in FIG. 3, can also associate a particular network perspective with the particular network context.

At block 414, the particular network perspective is rendered into an object configured to present the particular network perspective in a graphical user interface. In a specific implementation, the object rendering engine 208 renders the particular network perspective into an object. In an implementation, the object rendered by the object rendering engine 208 includes a dashboard with one or more widgets. The dashboard can provide contextual visibility and insight into network data traveling through the monitored/analyzed network, and can assist the network administrator identify the types of policies the user may want to enforce or configure. The dashboard can include one or more perspectives, each of which can provide a view of a given network from a different vantage point. For example, the dashboard can allow visualization of network data, usage or performance using the context of time, location, device identifier, or user identifier.

The one or more of the widgets can represent a different perspective of network activity on the WAN 104 and/or the LAN 106. Each widget may functionally render the network perspective into a format that is meaningful to a network administrator. Widgets may include bar graphs, pie charts, and other data visualizations. Widgets may also include textual lists that show the network perspectives rendered in a meaningful way. In an implementation, the object rendering engine 208 filters data provided to specific widgets through a network perspective. In some implementations, perspectives can function as a container for one or more widgets that are being provided with context-filtered network data.

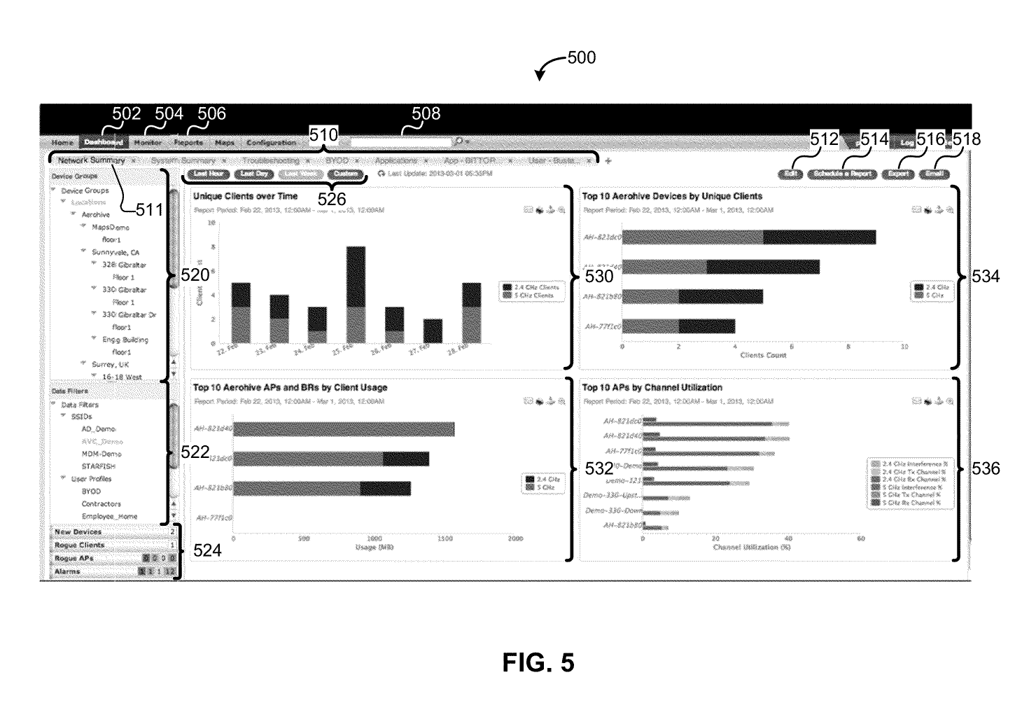

FIG. 5 depicts an example of a screen 500 for displaying a network summary perspective, in accordance with some implementations. In a specific implementation, the network summary perspective on the screen 500 provides a measure of network activity by a group of devices on the network. The screen 500 includes a dashboard tab 502, a monitor tab 504, a reports tab 506, and a search box 508.

The dashboard tab 502 provides the user with one or more perspectives of the network. In the example of FIG. 5, the dashboard tab 502 includes a perspective tab set 510, an edit button 512, a report scheduling button 514, an exporting button 516, and a send button 518.

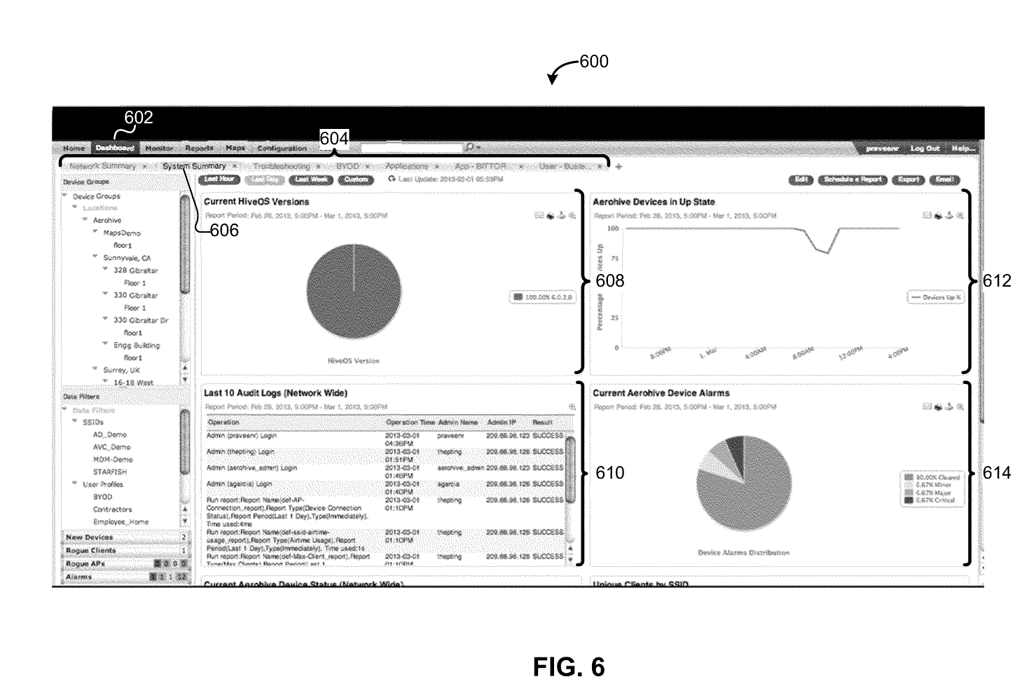

In a specific implementation, the perspective tab set 510 provides a set of tabs that show various perspectives of the network. Each of the various perspective show different measures of activity of groups of devices on the network. In the example of FIG. 5, the perspective tab set 510 includes a Network Summary Perspective Tab 511, a System Summary Perspective Tab, a Troubleshooting Perspective Tab, a BYOD Perspective Tab, an Applications Perspective Tab, a specific application perspective tab, and a specific user perspective tab. In the example of FIG. 5, the Network Summary Perspective Tab 511 is shown selected. Other tabs of the perspective tab set 510 are shown in FIGS. 6-11.

In the example of FIG. 5, the Network Summary Perspective Tab 511 provides widgets that depict perspectives relating to network activity. The Network Summary Perspective Tab 511 includes a location context pane 520, a user context pane 522, and a device context pane 524. The Network Summary Perspective Tab 511 further includes perspective duration buttons 526, a first perspective widget 530, a second perspective widget 532, a third perspective widget 534, and a fourth perspective widget 536.

In a specific implementation, the location context pane 520, the user context pane 522, and the device context pane 524 provide specific contexts of the network for which a user can generate perspectives.

In a certain implementation, the location context pane 520 shows the various locations of the group of devices accessing the network. In a specific implementation, the location context pane 520 is arranged hierarchically, as discussed herein. For instance, the location context pane 520 can show, at a first level in a geographical hierarchy, an organization (“Aerohive”) responsible for administering the network. At a second level in the geographical hierarchy, the location context pane 520 can show various physical cities the organization is present in. As shown in FIG. 5, the cities can be geographically dispersed from a city named “MapsDemo,” to cities named “Sunnyvale, Calif.” and “Surrey, UK.” At a third level in the geographical hierarchy, the location context pane 520 can show various buildings in a particular city. As shown in FIG. 5, the various buildings in “Sunnyvale, Calif.” may include 328 Gibraltar, 330 Gibraltar, 330 Gibraltar Dr., and the “Engg Building.” At a third level in the geographical hierarchy, the location context pane 520 can show floors of a particular building.

In a particular implementation, the user context pane 522 shows the users associated with the group of devices accessing the network. In a specific implementation, the user context pane 522 is arranged hierarchically, as discussed herein. For example, the user context pane 522 can show, at a first level in a user profile hierarchy, the subscriber station identifiers (SSIDs) and the user profiles of users of devices accessing the network. At a second level in the user profile hierarchy, the user context pane 522 can show particular SSIDs (e.g., “AD_Demo,” “AVC_Demo,” “MDM-Demo,” and “STARFISH) and/or User Profiles (e.g., “BYOD,” “Contractors,” and “Employee_Home”).

In a specific implementation, the device context pane 524 show various device contexts, including new devices, rogue devices, rogue APs, and Alarms. Numbers near the device contexts can show the number of devices falling within a particular device context.

In a certain implementation, the perspective duration buttons 526 provide a duration for the perspective widgets herein. In the example of FIG. 5, the perspective duration buttons 526 may include widgets to be populated with perspectives of network activity for the last hour, the last day, the last week, or a custom duration of time.

In a particular implementation, the first perspective widget 530, the second perspective widget 532, the third perspective widget 534, and the fourth perspective widget 536 provide specific perspectives with measures of network activity of groups of devices on the network. In some implementations, the first perspective widget 530 can provide the number of unique clients on the network over time. The second perspective widget 532 can provide the top ten access points and bridges by client usage. The third perspective widget 534 can provide the top ten network access devices by unique clients. The fourth perspective widget 536 can provide the top ten access points by channel utilization.

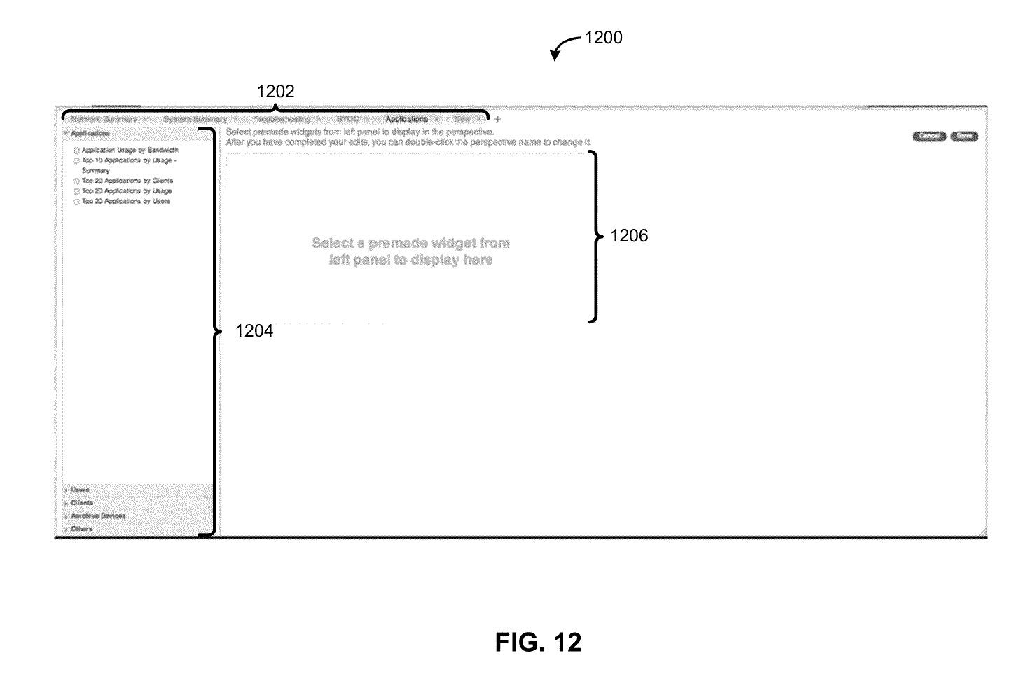

In a particular implementation, the edit button 512 allows the user to edit the widgets on the dashboard tab 502. More specifically, in a specific implementation, clicking the edit button 512 allows a user to add widgets to the dashboard tab 502, remove widgets from the dashboard tab 502, and/or edit parameters of the widgets on the dashboard tab 502. In some implementations, the edit button 512 directs the user to a custom tab creation screen, such as the screen 1200, shown in FIG. 12.

In a certain implementation, the report scheduling button 514 allows the user to schedule a report relating to the perspectives shown on the dashboard tab 502. In some implementations, the report scheduling button 514 directs the user to a report scheduling screen. The report scheduling screen may receive specific contexts and/or perspectives for generating a report. The report may represent network contexts and/or perspectives in various formats, such as a graphical format, a textual format, an animated format, a combination of any of the foregoing formats, or other format. In various implementations, the report scheduling screen may allow for the transmission of a report to a user, such as an administrator of the network.

In a specific implementation, the exporting button 516 allows the user to transmit network contexts and/or perspectives to a user of the network. The user may include the administrator of the network. In a particular implementation, the send button 518 allows network contexts and/or perspectives to be sent to a user of the network. In various implementations, user may include the administrator of the network.

FIG. 6 depicts an example of a screen 600 for displaying a system summary perspective, in accordance with some implementations. In the example of FIG. 6, the screen 600 includes a dashboard tab 602. The dashboard tab 602 provides the user with one or more perspectives of the network. The dashboard tab 602 includes a perspective tab set 604. In the example of FIG. 6, the perspective tab set 604 includes a set of tabs, including a System Summary Tab 606.

In a specific implementation, the System Summary Tab 606 provides widgets that depict perspectives relating to systems that access the network. The System Summary Tab 606 can include a first perspective widget 608, a second perspective widget 610, a third perspective widget 612, and a fourth perspective widget 614.

In a specific implementation, the first perspective widget 608 can provide the operating systems of devices accessing the network. The second perspective widget 610 can provide a number of audit logs for the network. The third perspective widget 612 can provide the number of devices in an up state in the network. The fourth perspective widget 614 can provide the current alarms of devices accessing the network.

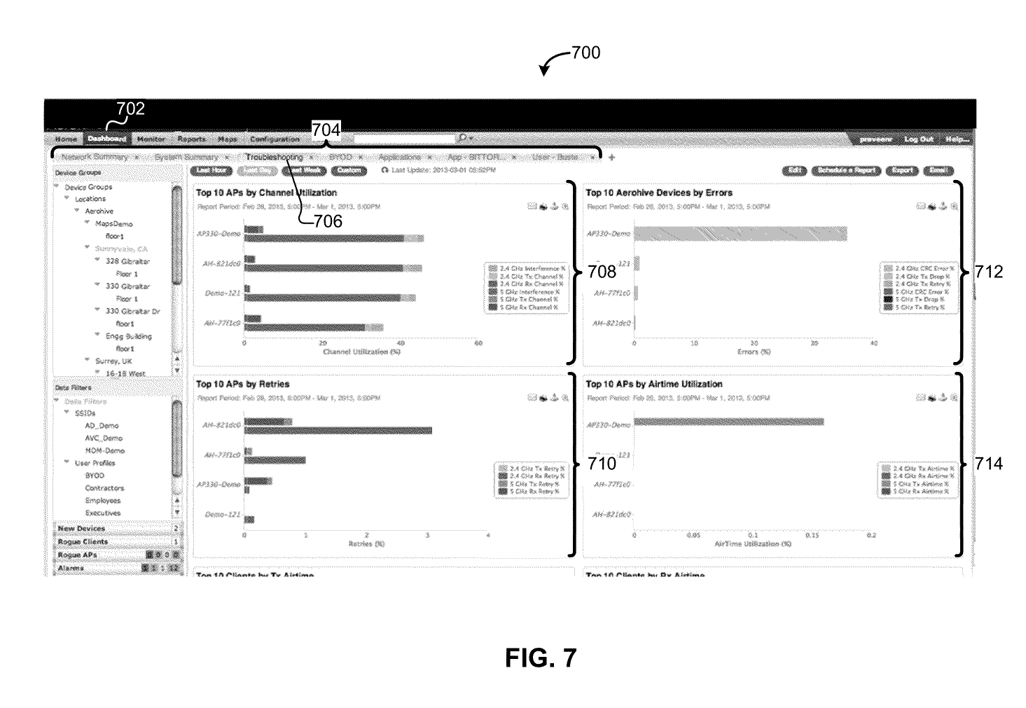

FIG. 7 depicts an example of a screen 700 for displaying a troubleshooting perspective, in accordance with some implementations. In the example of FIG. 7, the screen 700 includes a dashboard tab 702. The dashboard tab 702 provides the user with one or more perspectives of the network. The dashboard tab 702 includes a perspective tab set 704. In the example of FIG. 7, the perspective tab set 704 includes a set of tabs, including a Troubleshooting Tab 706.

In a specific implementation, the Troubleshooting Tab 706 provides widgets that depict perspectives relating to troubleshooting network activity. The Troubleshooting Tab 706 can include a first perspective widget 708, a second perspective widget 710, a third perspective widget 712, and a fourth perspective widget 714.

In a specific implementation, the first perspective widget 708 can provide the top access points by channel utilization. The second perspective widget 710 can provide the top access points by retries. The third perspective widget 712 can provide the top devices by errors. The fourth perspective widget 714 can provide the top access points by airtime utilization. One or more of the first perspective widget 708, the second perspective widget 710, the third perspective widget 712, and the fourth perspective widget 714 can provide context-based network usage/performance information according to wireless network frequencies (e.g., 2.4 GHz or 5 GHz). The information provided can include, for example, channel utilization, channel Tx/Rx retries, errors (e.g., CRC errors, Tx Drop, and Tx Retry), and airtime utilization (e.g., Tx/Rx airtime). Additional information provided can include any information provide an understanding of a problem or provide error stats for the network.

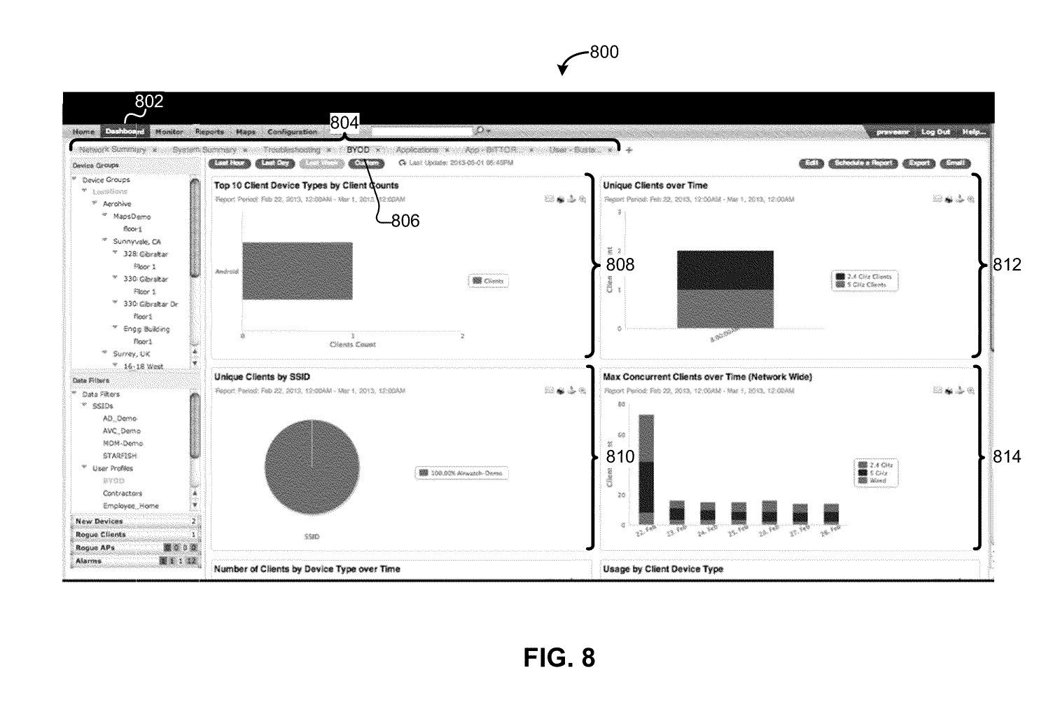

FIG. 8 depicts an example of a screen 800 for displaying a BYOD perspective, in accordance with some implementations. In the example of FIG. 8, the screen 800 includes a dashboard tab 802. The dashboard tab 802 provides the user with one or more perspectives of the network. The dashboard tab 802 includes a perspective tab set 804. In the example of FIG. 8, the perspective tab set 804 includes a set of tabs, including a BYOD Tab 806.

In a specific implementation, the BYOD Tab 806 provides widgets that depict perspectives relating to devices that fall under a BYOD regime. The BYOD Tab 806 can include a first perspective widget 808, a second perspective widget 810, a third perspective widget 812, and a fourth perspective widget 814.

In a specific implementation, the first perspective widget 808 can provide the top client device types by client counts. The second perspective widget 810 can provide the number of unique clients by SSID. The third perspective widget 812 can provide the number of unique clients over time. The fourth perspective widget 814 can provide the maximum concurrent clients over time, network wide. One or more of the first perspective widget 808, the second perspective widget 810, the third perspective widget 812, and the fourth perspective widget 814 can provide context-based network usage/performance information for devices qualifying as BYODs. The information provide can include, for example, view into client devices (e.g., trend view of the types of devices/operating system using the network, snapshot view of BYOD information), client usage trends (e.g., how many users are using on a daily basis?; peak capacity usage going to which users?), concurrent client usage over time, unique clients over time, and unique clients by wireless SSID.

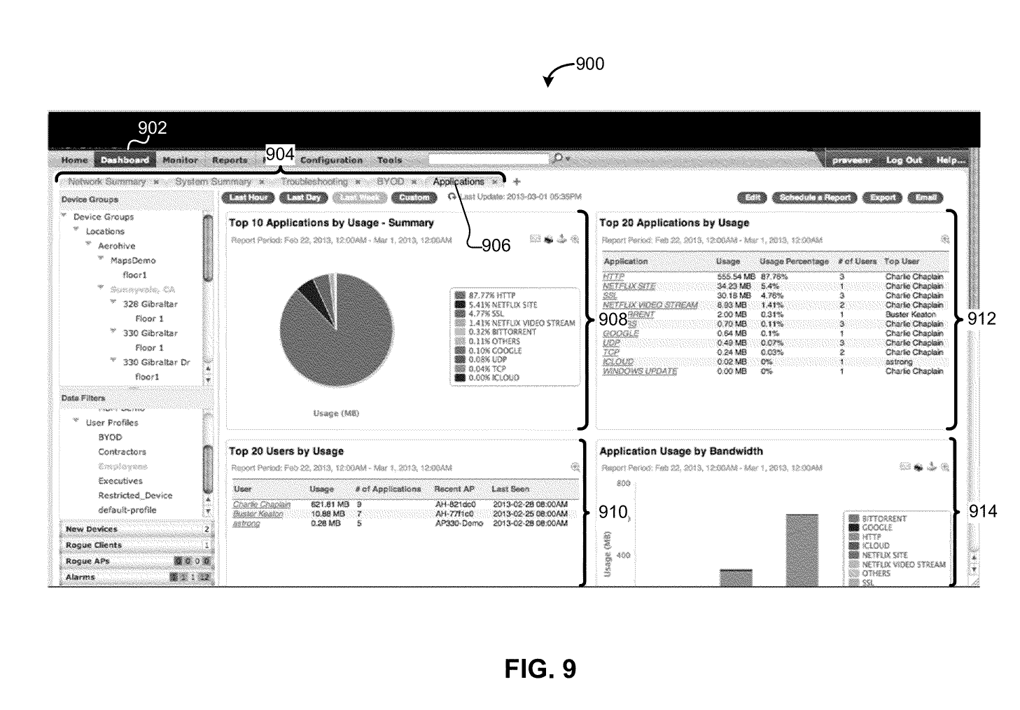

FIG. 9 depicts an example of a screen 900 for displaying an applications perspective, in accordance with some implementations. In the example of FIG. 9, the screen 900 includes a dashboard tab 902. The dashboard tab 902 provides the user with one or more perspectives of the network. The dashboard tab 902 includes a perspective tab set 904. In the example of FIG. 9, the perspective tab set 904 includes a set of tabs, including an Applications Tab 906.

In a specific implementation, the Applications Tab 906 provides widgets that depict perspectives relating to applications that devices on the network are trying to access using the network. The Applications Tab 906 can include a first perspective widget 908, a second perspective widget 910, a third perspective widget 912, and a fourth perspective widget 914.

In a specific implementation, the first perspective widget 908 can provide the top applications by usage. The second perspective widget 910 can provide a pie chart of the top users by network usage. The third perspective widget 912 can provide a list of the top applications by usage. The fourth perspective widget 914 can provide application usage by bandwidth. One or more of the first perspective widget 908, the second perspective widget 910, the third perspective widget 912, and the fourth perspective widget 914 can provide context-based network usage/performance information relating to network usage by application (e.g., top 10 applications, or top 20 applications), network usage by usage, and application usage by bandwidth. Additional information provided can include, for example, how many people are using the network for a particular application, who is using the application, and when and where the application is being used (e.g., application usage over the network according to geographic location of network access stations).

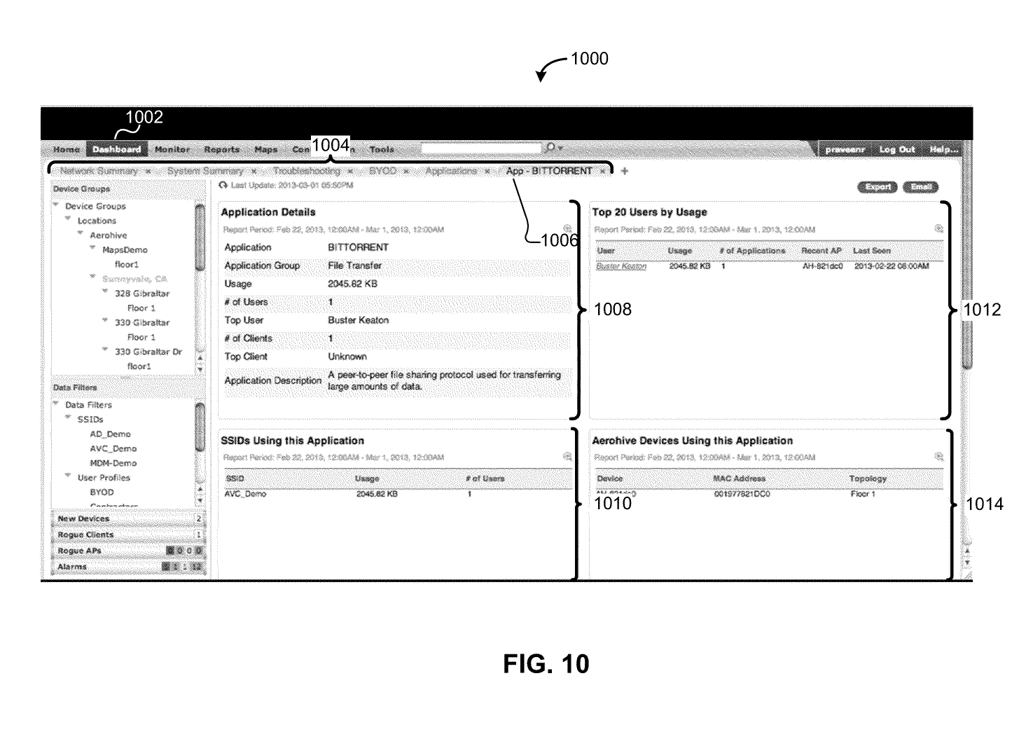

FIG. 10 depicts an example of a screen 1000 for displaying a particular application perspective, in accordance with some implementations. In the example of FIG. 10, the screen 1000 includes a dashboard tab 1002. The dashboard tab 1002 provides the user with one or more perspectives of the network. The dashboard tab 1002 includes a perspective tab set 1004. In the example of FIG. 10, the perspective tab set 1004 includes a set of tabs, including an Particular Application Tab 1006.

In a specific implementation, the Particular Application Tab 1006 provides widgets that depict perspectives relating to a particular application that devices on the network are trying to access using the network. The Particular Application Tab 1006 can include a first perspective widget 1008, a second perspective widget 1010, a third perspective widget 1012, and a fourth perspective widget 1014.

In a specific implementation, the first perspective widget 1008 can provide details of the particular application. The second perspective widget 1010 can provide a list of SSIDs of users using the particular application. The third perspective widget 1012 can provide a list of the top users of the application by usage. The fourth perspective widget 1014 can provide a list of network access devices using the particular application. One or more of the first perspective widget 1008, the second perspective widget 1010, the third perspective widget 1012, and the fourth perspective widget 1014 can provide context-based network usage/performance information for Bittorrent application usage over the network being monitored/analyzed.

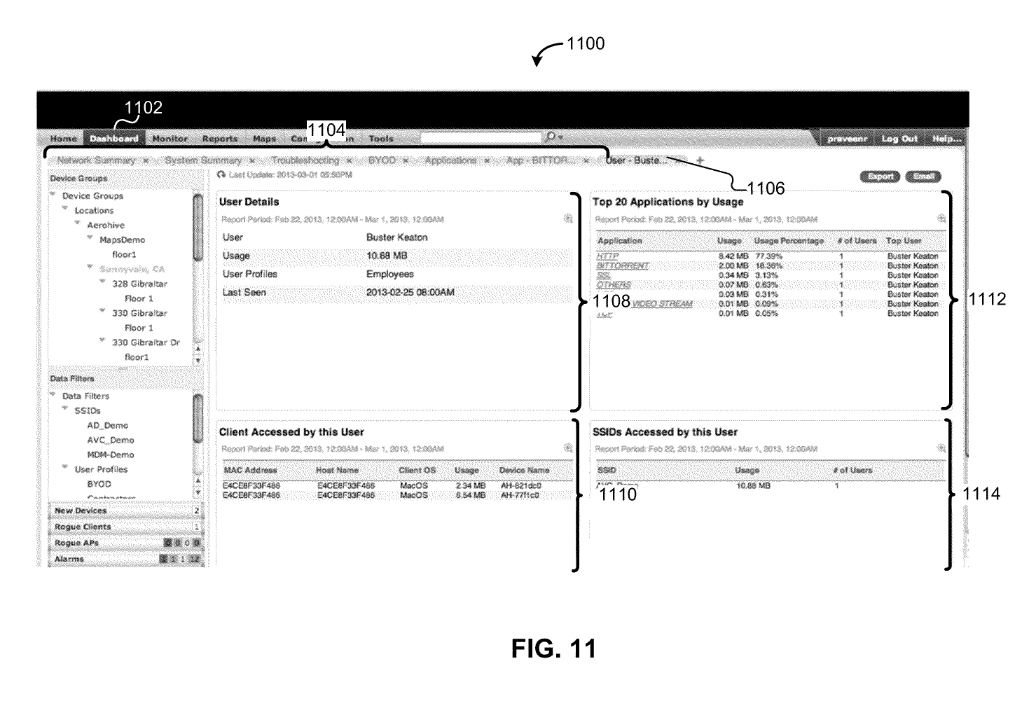

FIG. 11 depicts an example of a screen 1100 for displaying a particular user perspective, in accordance with some implementations. In the example of FIG. 11, the screen 1100 includes a dashboard tab 1102. The dashboard tab 1102 provides the user with one or more perspectives of the network. The dashboard tab 1102 includes a perspective tab set 1104. In the example of FIG. 11, the perspective tab set 1104 includes a set of tabs, including an Particular User Tab 1106.

In a specific implementation, the Particular User Tab 1106 provides widgets that depict perspectives relating to a particular user of the network. The Particular User Tab 1106 can include a first perspective widget 1108, a second perspective widget 1111, a third perspective widget 1112, and a fourth perspective widget 1114.

In a specific implementation, the first perspective widget 1108 can provide details of the particular user. The second perspective widget 1111 can provide a list of clients accessed by the particular user. The third perspective widget 1112 can provide a list of the top applications the particular user is using by usage. The fourth perspective widget 1114 can provide a list of SSIDs accessed by the particular user. One or more of the first perspective widget 1108, the second perspective widget 1111, the third perspective widget 1112, and the fourth perspective widget 1114 can provide context-based network usage/performance information for the user Buster Keaton. The information provided can include, for example, applications used over the network by usage, SSIDs accessed by the user, client devices used by the user to access the network, and additional user related data (e.g., user type, total data usage, and last seen).

FIG. 12 depicts an example of a screen 1200 for creating a custom perspective, in accordance with some implementations. In the example of FIG. 12, the screen 1200 has not been populated with custom widgets. In the example of FIG. 12, the screen 1200 includes a perspective tab set 1202, a context pane 1204, and a new perspective widget pane 1206. In a specific implementation, the perspective tab set 1202 provides a set of tabs for the custom perspective. A user can associate the custom perspective with one of the perspective tab set 1202. In a particular implementation, the context pane 1204 includes various contexts the user can associate the custom perspective with. Various contexts illustrated include contexts related to applications, such as Application Usage by Bandwidth, Top Applications by Usage, Top Applications by Clients, Top Applications by Usage, and Top Applications by Usage. Various contexts may further include contexts related to users, contexts related to Clients, contexts related to network access devices, and contexts related to other factors. For each context, a premade widget can be selected for display.

In a specific implementation, the new perspective widget pane 1206 may allow the user to place a premade widget therein. The new perspective widget pane 1206 may allow the user to select an area therein. Selection of the area may direct the user to a widget selection screen.

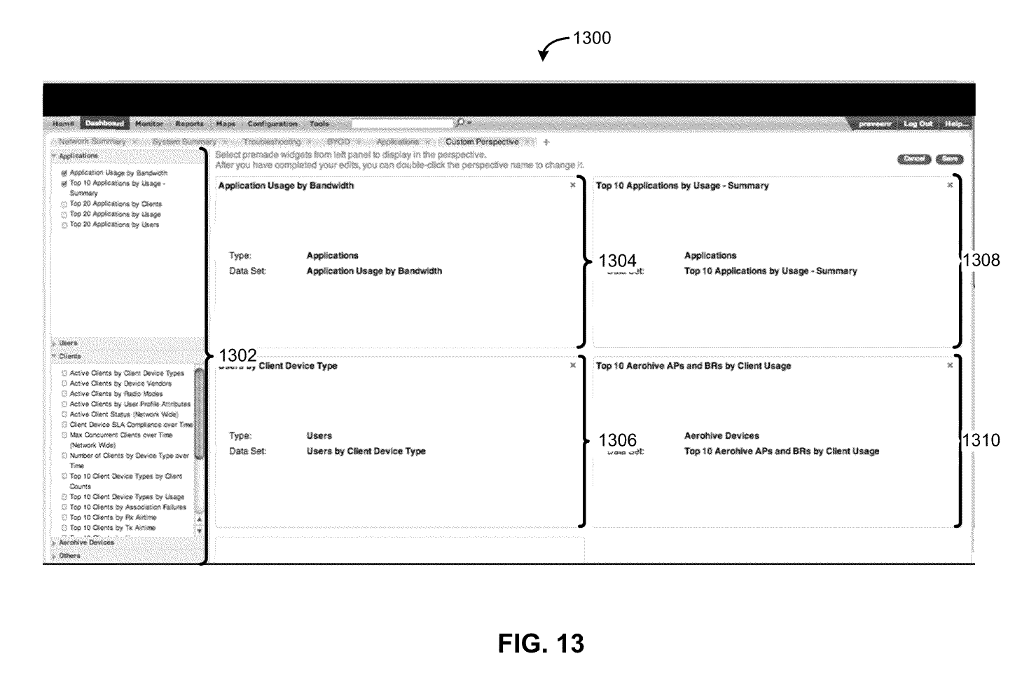

FIG. 13 depicts an example of a screen 1300 for creating a custom perspective, in accordance with some implementations. In the example of FIG. 13, the screen 1300 has been filled with custom widgets, each depicting a custom perspective of network activity. None of the custom widgets of the screen 1300 has been populated with data. In the example of FIG. 13, the screen 1300 includes a context pane 1302, a first custom perspective widget 1304, a second custom perspective widget 1306, a third custom perspective widget 1308, and a fourth custom perspective widget 1310.

In a specific implementation, the context pane 1302 includes various contexts the user can associate custom perspectives with. In this example, the user has selected contexts associated with application usage by bandwidth and the top applications by usage. Though not shown in FIG. 13, the user has also selected contexts associated with users by client device type and the top access points and bridges by client usage.

In a particular implementation, the first custom perspective widget 1304 includes a widget that will show the application usage by bandwidth. The second custom perspective widget 1306 includes a widget that will show users by client device type. The third custom perspective widget 1308 includes a widget that will show the top applications by usage. The fourth custom perspective widget 1310 includes a widget that will show the top access points by client usage.

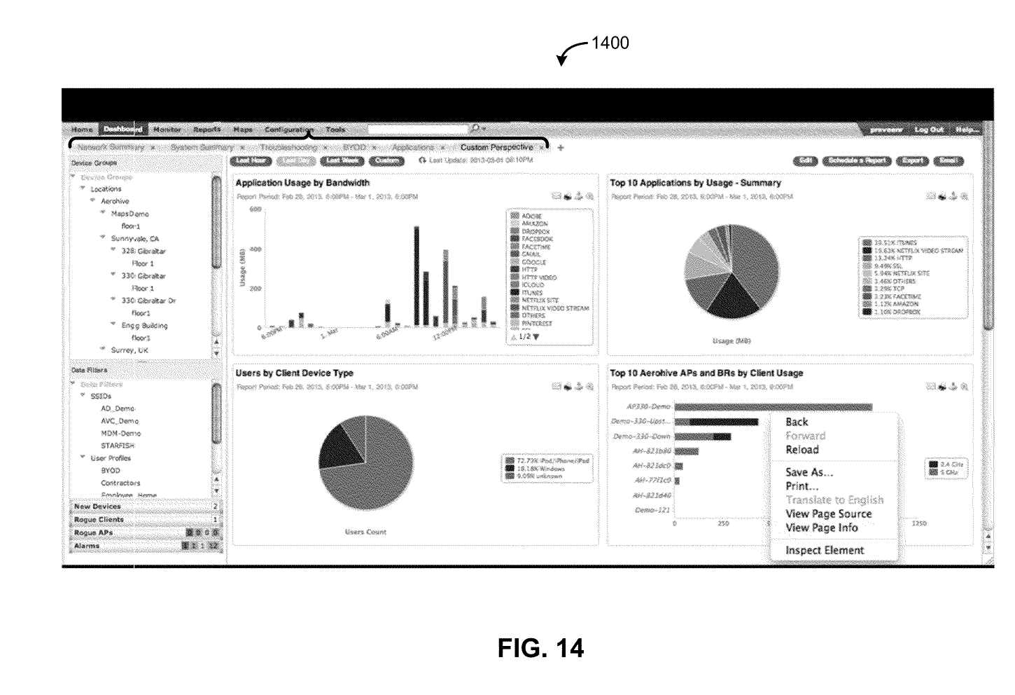

FIG. 14 depicts an example of a screen 1400 for displaying a custom perspective, in accordance with some implementations. In the example of FIG. 14, the screen 1400 has been filled with custom widgets, each depicting a custom perspective of network activity. Each of the custom widgets of the screen 1400 has been populated with data. The custom widgets on the screen 1400 may correspond to the custom widgets on the screen 1300, shown in FIG. 13.

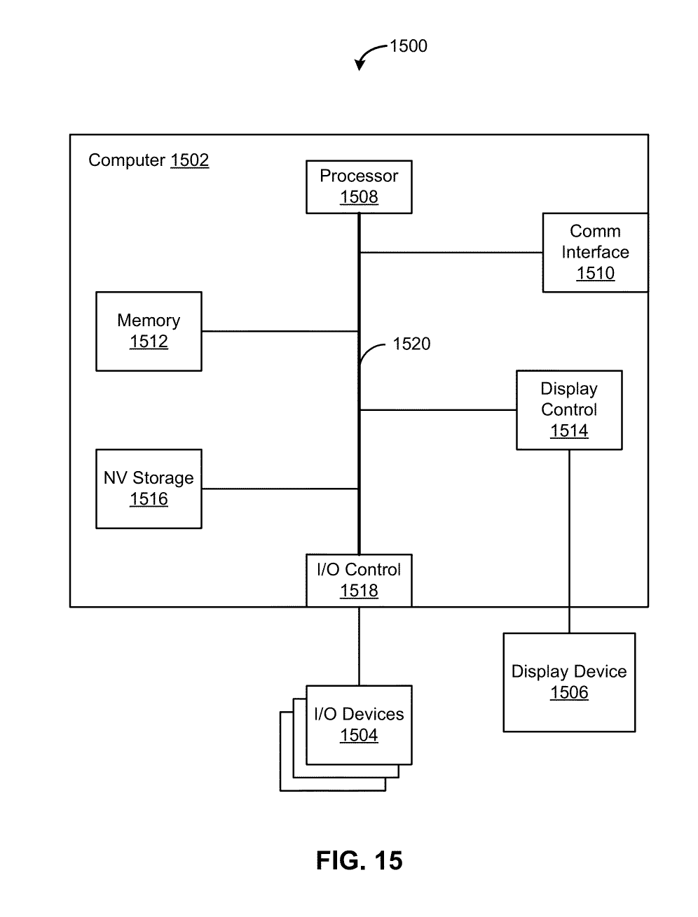

FIG. 15 shows an example of a computer system 1500 on which techniques described in this paper can be implemented. The computer system 1500 can be a conventional computer system that can be used as a client computer system, such as a wireless client or a workstation, or a server computer system. The computer system 1500 includes a computer 1502, I/O devices 1504, and a display device 1506. The computer 1502 includes a processor 1508, a communications interface 1510, memory 1512, display controller 1514, non-volatile storage 1516, and I/O controller 1518. The computer 1502 may be coupled to or include the I/O devices 1504 and display device 1506.

The computer 1502 interfaces to external systems through the communications interface 1510, which may include a modem or network interface. It will be appreciated that the communications interface 1510 can be considered to be part of the computer system 1500 or a part of the computer 1502. The communications interface 1510 can be an analog modem, ISDN modem, cable modem, token ring interface, satellite transmission interface (e.g. “direct PC”), or other interfaces for coupling a computer system to other computer systems.

The processor 1508 may be, for example, a conventional microprocessor such as an Intel Pentium microprocessor or Motorola power PC microprocessor. The memory 1512 is coupled to the processor 1508 by a bus 1520. The memory 1512 can be Dynamic Random Access Memory (DRAM) and can also include Static RAM (SRAM). The bus 1520 couples the processor 1508 to the memory 1512, also to the non-volatile storage 1516, to the display controller 1514, and to the I/O controller 1518.

The I/O devices 1504 can include a keyboard, disk drives, printers, a scanner, and other input and output devices, including a mouse or other pointing device. The display controller 1514 may control in the conventional manner a display on the display device 1506, which can be, for example, a cathode ray tube (CRT) or liquid crystal display (LCD). The display controller 1514 and the I/O controller 1518 can be implemented with conventional well known technology.

The non-volatile storage 1516 is often a magnetic hard disk, an optical disk, or another form of storage for large amounts of data. Some of this data is often written, by a direct memory access process, into memory 1512 during execution of software in the computer 1502. One of skill in the art will immediately recognize that the terms “machine-readable medium” or “computer-readable medium” includes any type of storage device that is accessible by the processor 1508 and also encompasses a carrier wave that encodes a data signal.

The computer system 1500 is one example of many possible computer systems which have different architectures. For example, personal computers based on an Intel microprocessor often have multiple buses, one of which can be an I/O bus for the peripherals and one that directly connects the processor 1508 and the memory 1512 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1512 for execution by the processor 1508. A Web TV system, which is known in the art, is also considered to be a computer system, but it may lack some of the features shown in FIG. 15, such as certain input or output devices. A typical computer system will usually include at least a processor, memory, and a bus coupling the memory to the processor.

Though FIG. 15 shows an example of the computer system 1500, it is noted that the term “computer system,” as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 15.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

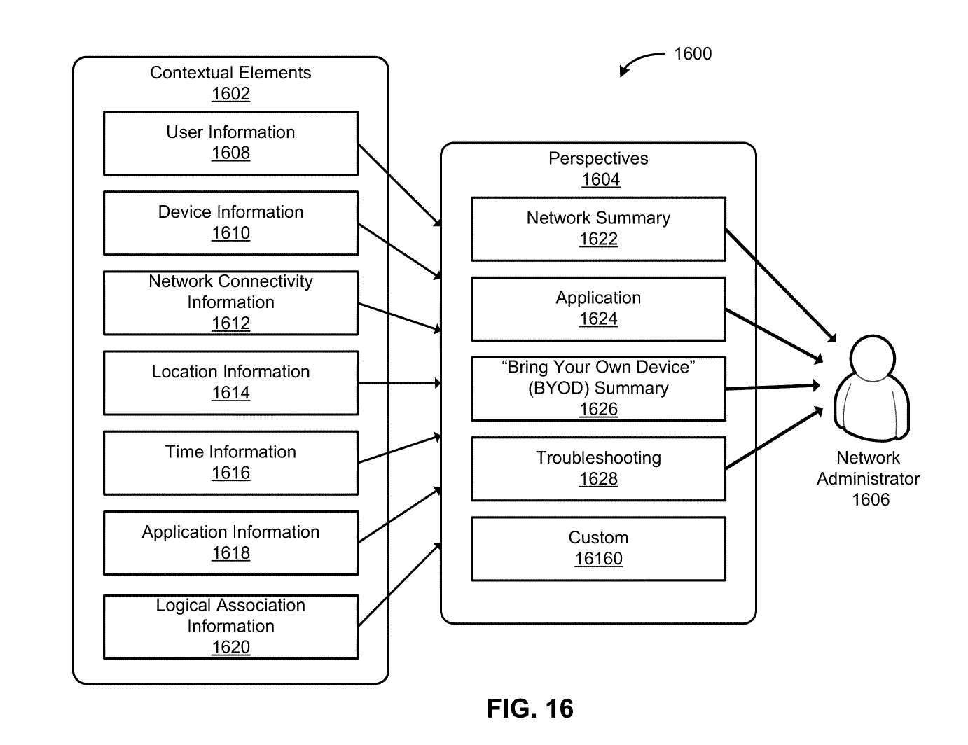

FIG. 16 depicts a diagram 1600 illustrating examples of contextual elements 1602 and examples of various perspective views 1604 that can utilize the contextual elements 1602 in providing an network administrator 1606 with network usage and performance data regarding a network in accordance with some implementations. As shown, examples of contextual elements 1602 can include user information 1608 (e.g., user identifier, user type, or user group), device information 1610 (e.g., manufacturer, model, device type, or operating system of a network-enabled user device), network connectivity information 1612 (e.g., Wireless SSID, wireless technology, encryption, layer-2 information, or layer-16 information), location information 1614 (e.g., network usage or performance through one or more network access stations at a geographic location), time information 1616 (e.g., network usage or performance within a window of time), application information 1618 (e.g., network data associated with specific application, such as Apple® FaceTime), logical association information 1620 (e.g., network usage or performance through one or more network access stations associated with a group of high schools), and the like. The network administrator 1606 can view the network usage or performance data through the various perspective views 1604, including a network summary perspective 1622, application perspective 1624, a “Bring Your Own Device” (BYOD) summary perspective 1626, a troubleshooting perspective 1628, and a custom perspective 16160, which can be created by the network administrator 1606 according to their preferences.

A detailed description of one or more embodiments of the invention is provided in this paper along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

What is claimed is:

1. A method comprising:
receiving particular network usage information, the particular network usage information representing network activity of a particular device on a network;
associating the particular network usage information with a network context, the network context representing circumstances of the network activity of the particular device;
associating the network context with a particular network perspective, the network particular perspective representing a network activity of a group of devices on the network;
rendering the particular network perspective into an object, the object being configured to present the particular network perspective in a graphical user interface.

2. The method of claim 1, wherein the particular device comprises one or more of a network access system, a wireless system, and a wired system.

3. The method of claim 1, wherein the group of devices comprises one or more of a network access system, a wireless system, and a wired system.

4. The method of claim 1, further comprising collecting information about the network activity by the group of devices before receiving the particular network usage information.

5. The method of claim 1, wherein the network comprises an edge network, and the particular network usage information is related to the edge network.

6. The method of claim 1, wherein the network comprises an edge network, and the network activity of the group of devices is associated with the group of devices in relation to the edge network.

7. The method of claim 1, wherein the network comprises an edge network, and the method further comprises interfacing with a core network.

8. The method of claim 1, wherein the network activity of the particular device comprises one or more of: a location of the particular device, a user identifier of a user of the particular device, connectivity parameters used to connect the particular device to the network, an access time of the particular device to the network, an application of the particular device used to access the network, and a logical network access group the particular device belongs to.

9. The method of claim 1, wherein the circumstances comprise one or more of: a common location of one or more of the group of devices, a user identifier of a user of one or more of the group of devices, connectivity parameters used to connect one or more of the group of devices to the network, an access time of one or more of the group of devices to the network, an application of one or more of the group of devices commonly used to access the network, and a logical network access group of one or more of the group of devices.

10. The method of claim 1, wherein the network activity of the group of devices comprises: network access parameters of the group of devices, system configurations of the group of devices, networked applications of the group of devices, Bring Your Own Device designations of the group of devices, network troubleshooting parameters of the group of devices, and custom parameters of the group of devices.

11. The method of claim 1, wherein the particular network perspective comprises one or more of: a network summary of the group of devices, an application perspective of the group of devices, a bring-your-own-device perspective for the group of devices, a troubleshooting perspective for the group of devices, or a custom perspective for the group of devices.

12. The method of claim 1, wherein the object is adapted to be integrated into a webpage or an application for an administrator of the network.

13. The method of claim 1, wherein the object comprises an embeddable widget.

14. The method of claim 1, wherein the graphical user interface comprises another object, the other object rendering another particular network perspective, the other particular network perspective representing a third measure of network activity, the third measure of network activity being by the group of devices on the network.

15. The method of claim 1, wherein the object comprises one or more of: a pie chart, a bar graph, and a line chart.

16. The method of claim 1, wherein associating the particular network usage information with the network context comprises applying a context filter to the particular network usage information, the context filter translating the particular measure of network activity to the circumstances of the network activity.

17. The method of claim 1, wherein associating the network context with the particular network perspective comprises applying a network perspective filter to the network context, the perspective filter translating the circumstances of the network activity to the second measure of the network activity.

18. The method of claim 1, further comprising generating a report, the report representing the particular network perspective in at least a partially textual format.

19. The method of claim 18, further comprising transmitting the report to an administrator of the network.

20. A system comprising:
a network data collection engine;
a context association engine coupled to the network data collection engine;
a perspective association engine coupled to the context association engine;
an object rendering engine coupled to the perspective association engine;
wherein, in operation:
the network data collection engine receives particular network usage information, the particular network usage information representing network activity of a particular device on a network;
the context association engine associates the particular network usage information with a network context, the network context representing circumstances of the network activity of the particular device;
the perspective association engine associates the network context with a particular network perspective, the network particular perspective representing a network activity of a group of devices on the network;
the object rendering engine renders the particular network perspective into an object, the object being configured to present the particular network perspective in a graphical user interface.

21. The system of claim 20, wherein the particular device comprises one or more of a network access system, a wireless system, and a wired system.

22. The system of claim 20, wherein the group of devices comprises one or more of a network access system, a wireless system, and a wired system.

23. The system of claim 20, wherein the network comprises an edge network, and the particular network usage information is related to the edge network.

24. The system of claim 20, wherein the network comprises an edge network, and the network activity of the group of devices is associated with the group of devices in relation to the edge network.

25. The system of claim 20, wherein the network comprises an edge network, and the network data collection engine is adapted to interface with a core network.

26. The system of claim 20, wherein the network activity of the particular device comprises one or more of: a location of the particular device, a user identifier of a user of the particular device, connectivity parameters used to connect the particular device to the network, an access time of the particular device to the network, an application of the particular device used to access the network, and a logical network access group the particular device belongs to.

27. The system of claim 20, wherein the circumstances comprise one or more of: a common location of one or more of the group of devices, a user identifier of a user of one or more of the group of devices, connectivity parameters used to connect one or more of the group of devices to the network, an access time of one or more of the group of devices to the network, an application of one or more of the group of devices commonly used to access the network, and a logical network access group of one or more of the group of devices.

28. The system of claim 20, wherein the network activity of the group of devices comprises: network access parameters of the group of devices, system configurations of the group of devices, networked applications of the group of devices, Bring Your Own Device designations of the group of devices, network troubleshooting parameters of the group of devices, and custom parameters of the group of devices.

29. The system of claim 20, wherein the particular network perspective comprises one or more of: a network summary of the group of devices, an application perspective of the group of devices, a bring-your-own-device perspective for the group of devices, a troubleshooting perspective for the group of devices, or a custom perspective for the group of devices.

30. The system of claim 20, wherein the object is adapted to be integrated into a webpage or an application for an administrator of the network.

31. The system of claim 20, wherein the object comprises an embeddable widget.

32. The system of claim 20, wherein the graphical user interface comprises another object, the other object rendering another particular network perspective, the other particular network perspective representing a third measure of network activity, the third measure of network activity being by the group of devices on the network.

33. The system of claim 20, wherein the object comprises one or more of: a pie chart, a bar graph, and a line chart.

34. The system of claim 20, wherein the context association engine is adapted to apply a context filter to the particular network usage information, the context filter translating the particular measure of network activity to the circumstances of the network activity.

35. The system of claim 20, wherein the perspective association engine is adapted to apply a network perspective filter to the network context, the perspective filter translating the circumstances of the network activity to the second measure of the network activity.

36. The system of claim 20, further comprising generating a report, the report representing the particular network perspective in at least a partially textual format.

37. The system of claim 20, further comprising transmitting the report to an administrator of the network.

38. The system of claim 20, wherein the system is incorporated on a network administration system configured to manage an edge network.

39. A system comprising:
means for receiving particular network usage information, the particular network usage information representing network activity of a particular device on a network;
means for associating the particular network usage information with a network context, the network context representing circumstances of the network activity of the particular device;
means for associating the network context with a particular network perspective, the network particular perspective representing a network activity of a group of devices on the network;
means for rendering the particular network perspective into an object, the object being configured to present the particular network perspective in a graphical user interface.
